(19) United States
(12) Patent Application Publication
(10) Pub. No.: US 2020/0334611 A1
(43) Pub. Date: Oct. 22, 2020

(54) SYSTEMS AND METHODS FOR PROVIDING A USER INTERFACE TO EMPLOYEES OF A QUICK SERVICE RESTAURANT

(71) Applicant: HM ELECTRONICS, INC., Poway, CA (US)

(72) Inventors: James Thomas Silane, San Diego, CA (US); David Kenneth Mattox, Temecula, CA (US)

(21) Appl. No.: 16/385,522

(22) Filed: Apr. 16, 2019

(51) Int. Cl. G06Q 10/06; G06F 9/54; G06F 9/451

(52) U.S. Cl. CPC G06Q 10/06393; G06Q 10/063114; G06Q 50/12; G06F 9/542; G06F 9/451; G06Q 10/06395

(57) ABSTRACT

Systems and methods for providing a user interface to employees of a quick service restaurant are disclosed. Exemplary implementations may: obtain, from a timing system that includes one or both of a timer and/or a sensor, timing information that represents service durations for individual instances of service being provided at the quick service restaurant; obtain event information that defines an event; determine, during event duration, values of the one or more service metrics specified by the event objective information for the quick service restaurant based on the timing information; obtain one or more sets of values for external service metrics; determine a current ranking order of the quick service restaurant and the other quick service restaurants for the event; and effectuate presentation on the user interface of a representation of the determined current ranking order.

### FIELD OF THE DISCLOSURE

The present disclosure relates to systems and methods for providing a user interface to employees of a quick service restaurant, and for providing a location-specific user interface to enable gamification for employees of a quick service restaurant.

### BACKGROUND

Quick service restaurants are known. Measuring how long it takes to provide service to individual customers at quick service restaurants is known. Comparing performance measurements between, e.g., employees, is known.

### SUMMARY

One aspect of the present disclosure relates to a system configured for providing a user interface to employees of a quick service restaurant. The system may include one or more hardware processors configured by machine-readable instructions, and/or other components. The processor(s) may be configured to obtain, from a timing (sub)system that includes one or both of a timer and/or a sensor, timing information that represents service durations for individual instances of service being provided at the quick service restaurant. The processor(s) may be configured to obtain event information that defines an event, such as, by way of non-limiting example, a contest. The event information may include event timing information, event participant information, and event objective information for the event. The event timing information may specify an event start time and an event stop time for the event, thereby defining an event duration between the event start time and the event stop time, the event participant information identifying other quick service restaurants participating in the event. The event objective information may specify one or more service metrics on which the participating quick service restaurants are competing during the event. The processor(s) may be configured to determine, during the event duration, values of the one or more service metrics specified by the event objective information for the quick service restaurant based on the timing information. The processor(s) may be configured to obtain, during the event duration, one or more sets of values for external service metrics. Individual sets of values for external service metrics may correspond to individual ones of the other quick service restaurants participating in the event. Individual sets of values for external service metrics may be based on service durations for individual instances of service being provided at the individual ones of the other quick service restaurants during the event duration. The processor(s) may be configured to determine a current ranking order of the quick service restaurant and the other quick service restaurants for the event. The current ranking order may be based on the determined values of the one or more service metrics and the obtained one or more sets of values for external service metrics. The processor(s) may be configured to effectuate presentation on the user interface, during the event duration, of a representation of the determined current ranking order. The representation may include one or more of the determined values of the one or more service metrics and the obtained one or more sets of values for external service metrics. The representation may further include a visual indication that depicts where the quick service restaurant is currently ranked within the determined ranking order.

Another aspect of the present disclosure relates to a method for providing a user interface to employees of a quick service restaurant. The method may include obtaining, from a timing (sub)system that includes one or both of a timer and/or a sensor, timing information that represents service durations for individual instances of service being provided at the quick service restaurant. The method may include obtaining event information that defines an event, such as, by way of non-limiting example, a contest. The event information may include event timing information, event participant information, and event objective information for the event. The event timing information may specify an event start time and an event stop time for the event, thereby defining an event duration between the event start time and the event stop time. The event participant information may identify other quick service restaurants participating in the event. The event objective information may specify one or more service metrics on which the participating quick service restaurants are competing during the event. The method may include determining, during the event duration, values of the one or more service metrics specified by the event objective information for the quick service restaurant based on the timing information. The method may include obtaining, during the event duration, one or more sets of values for external service metrics. Individual sets of values for external service metrics may correspond to individual ones of the other quick service restaurants participating in the event. Individual sets of values for external service metrics may be based on service durations for individual instances of service being provided at the individual ones of the other quick service restaurants during the event duration. The method may include determining a current ranking order of the quick service restaurant and the other quick service restaurants for the event. The current ranking order may be based on the determined values of the one or more service metrics and the obtained one or more sets of values for external service metrics. The method may include effectuating presentation on the user interface, during the event duration, of a representation of the determined current ranking order. The representation may include one or more of the determined values of the one or more service metrics and the obtained one or more sets of values for external service metrics. The representation may further include a visual indication that depicts where the quick service restaurant is currently ranked within the determined ranking order.

As used herein, any association (or relation, or reflection, or indication, or correspondency) involving servers, processors, client computing platforms, timing information, service durations, events, times, dates, contests, participants, service metrics, values for service metrics, ranking orders, user interfaces, presentations, representations, durations, completions, indicators, indications, persons, vehicles, results, awards, notifications, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for providing a user interface to employees of a quick service restaurant, in accordance with one or more implementations.

FIG. 2 illustrates a method for providing a user interface to employees of a quick service restaurant, in accordance with one or more implementations.

FIG. 3 illustrates an exemplary user interface as may be provided to employees of a quick service restaurant by a system as described in this disclosure, in accordance with one or more implementations.

FIG. 4 and FIG. 5 illustrate exemplary user interfaces as may be provided to employees of a quick service restaurant by a system as described in this disclosure, in accordance with one or more implementations.

FIG. 6 illustrates an exemplary user interface as may be presented when a quick service restaurant has won an award in an event, as described in this disclosure.

FIG. 7 illustrates an exemplary user interface as may be presented to provide context-specific feedback to a quick service restaurant, as described in this disclosure.

### DETAILED DESCRIPTION

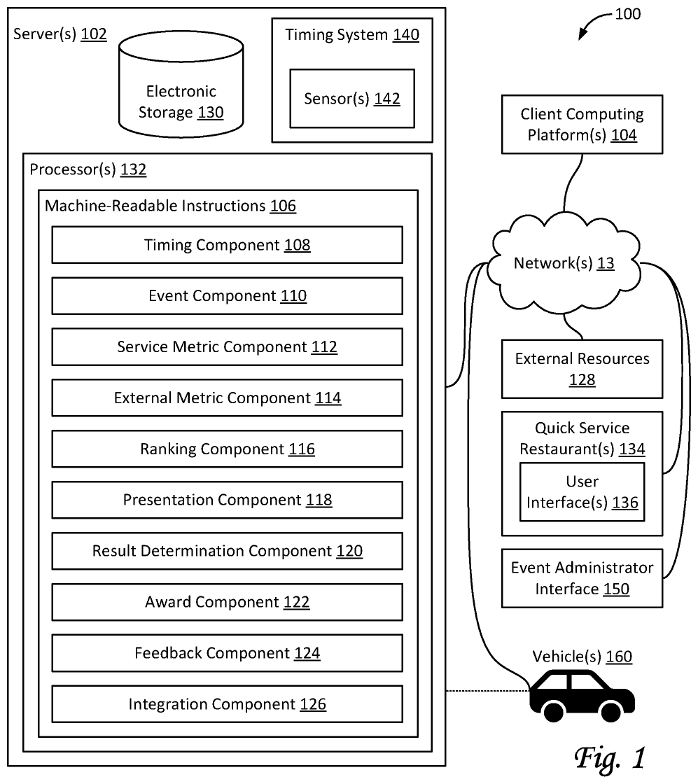

FIG. 1 illustrates a system 100 configured for providing a user interface 136 to employees of a quick service restaurant 134, in accordance with one or more implementations. Quick service restaurants 134 may include a first quick service restaurant, a second quick service restaurant, a third quick service restaurant, and so forth. User interfaces 136 may include a first user interface associated with the first quick service restaurant, a second user interface associated with the second quick service restaurant, a third user interface associated with the third quick service restaurant, and so forth. The first user interface may be configured to present information to the employees of the first quick service restaurant. The presented information may include information about service metrics and/or other performance indicators pertaining to the operation of the first quick service restaurant. Additionally, the presented information may include external information about external service metrics and/or other external performance indicators pertaining to the operation of other quick service restaurants. For example, the first user interface could present a ranking of the total number of customers served this week, month, or year, for multiple quick service restaurants 134. In some implementations, such a presentation may be referred to as a leaderboard.

In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104, one or more user interfaces 136, an event administrator interface 150, and/or one or more other components of system 100.

Server(s) 102 may be configured by machine-readable instructions 106. Machine-readable instructions 106 may include one or more instruction components. The instruction components may include computer program components. The instruction components may include one or more of timing component 108, event component 110, service metric component 112, external metric component 114, ranking component 116, presentation component 118, result determination component 120, award component 122, feedback component 124, integration component 126, and/or other instruction components.

Timing component 108 may be configured to determine and/or obtain timing information. In some implementations, timing component 108 may be configured to obtain timing information from a timing system 140 (or subsystem) that includes one or more sensors 142, such as, by way of non-limiting example, one or more timers, timing sensors, and/or one or more other sensors. In some implementations, timing information may represent service durations for individual instances of service being provided at quick service restaurant 134. In some implementations, timing information may be based on service durations for individual instances of service being provided at quick service restaurant 134. Service durations may be defined by the time between a (service) start time or begin time and a (service) stop time or end time. In some implementations, quick service restaurant 134 may be a drive-thru restaurant. In some implementations, the start time may be defined as the moment a vehicle 160 enters the drive-thru (e.g., passes a particular point on the road surface of the drive-thru). In some implementations, the start time may be defined as the moment people in vehicle 160 begin or complete their order, or pay for their order. In some implementations, the end time of a service duration may be defined as the moment vehicle 160 exits the drive-thru (e.g., passes a particular point on the road surface of the drive-thru). In some implementations, the end time may be defined as the moment people in vehicle 160 receive their order, or pay for their order. Start times and end times for different customers may be interleaved, such that individual service durations partially overlap with other service durations. Service durations may include a first service duration, a second service duration, a third service duration, and so forth. Vehicles 160 may include a first vehicle, a second vehicle, a third vehicle, and so forth. In some implementations, individual instances of service being provided at quick service restaurant 134 may include a first instance of service being provided to a first person in the first vehicle, a second instance of service being provided to one or more people in the second vehicle, and so forth.

Event component 110 may be configured to obtain event information that defines one or more events. The events may include a first event, a second event, a third event, and so forth. By way of non-limiting example, the event information may include one or more of event timing information, event participant information, event objective information for a particular event, and/or other information related to one or more events. In some implementations, events may include one or more contests, challenges, and/or other competitions. By way of non-limiting example, the event timing information for an individual event may specify an event start time and an event stop time for the event, thereby defining an event duration between the event start time and the event stop time. In some implementations, the event timing information may specify an event start date and/or an event stop date, thereby defining an event date range. The first event may be associated with a first event duration, the second event may be associated with the second event duration, the third event may be associated with the third event duration, and so forth. In some implementations, the event duration may be defined as a duration between 2 and 4 hours.

In some implementations, individual events may span multiple days. For example, a particular event may last a week, a month, or another multi-day period. In some implementations, a particular event may include individual rounds of competition occurring on different days. For example, a first contest may span every Friday from 11 a.m. to 2 p.m. for 3 months. For example, a second contest may span every Monday through Thursday from 6 a.m. to 10 a.m. for 2 months. For example, a third contest may span every Saturday and Sunday from 9 a.m. to 11 a.m., between an event start date and an event stop date that are about 10 weeks apart. In these examples, the portion of the contest that falls on a single day may be referred to as a round, or a daily round.

Event participant information may identify one or more quick service restaurants that are (or will be) participating in one or more events. For example, a particular event may include quick service restaurant 134 and one or more other quick service restaurants (e.g., operated by the same franchisee, located in the same geographical region, owned by the same owner, and/or otherwise having one or more characteristics in common). For a particular event, the set of quick service restaurants that are participating in the particular event may be referred to as the participating quick service restaurants or the set of participating quick service restaurants.

Event objective information may specify one or more service metrics on which individual ones of the participating quick service restaurants are competing during a particular event. By way of non-limiting example, the one or more service metrics may include one or more of average service duration per instance of service being provided at the quick service restaurant, percentage of the instances of service being provided for which the service duration is at or below a service duration goal, number of instances of service being provided at the quick service restaurant, and/or percentage reached of a goal number of instances of service being provided at an individual quick service restaurant. In some implementations, one or more service metrics may be based (at least in part) on information from the one or more points-of-sale (e.g., total sales, average sales per instance of service, etc.). Service metrics that combine service duration and information from a point-of-sale (POS) are envisioned within the scope of this disclosure. Determining the values of the one or more service metrics may be performed during the event duration, during a predetermined time period, at the completion of the event duration, and/or at the completion of the predetermined time period. For example, the average service duration per instance of service being provided at quick service restaurant 134 for the first contest (described above) may be determined by adding any service durations for instances of service provided on a Friday between 11 a.m. and 2 p.m. and dividing this total duration by the number of these instances.

In some implementations, events may be associated with one or more awards that can be awarded to any of the participating quick service restaurants. Some awards may be solely based on one or more service metrics for a single quick service restaurant. In some implementations, an award may be associated with an event. In some implementations, an award may be associated with a performance indicator and/or goal. Some awards may be based on comparing one or more service metrics among multiple quick service restaurants (e.g., all participating quick service restaurants). Some awards may require a combination of two or more (sequential and/or contemporaneous) accomplishments. In some implementations, an award may include an accessory for an avatar or character. In some implementations, an award may be a tag or flair that is displayed or otherwise presented in conjunction with an avatar or character. In some implementations, an award may be to animate the avatar or character with some sweet dance moves. In some implementations, an award may be negative, in the sense that the avatar of a losing quick service restaurant is changed to reflect the shame or sadness of losing (e.g., by wearing a dunce cap, or by an animation of the character making a sad face). In some implementations, event component 110 may be configured to obtain event information from an event administrator, event administrator interface 150, and/or external resource 128.

Service metric component 112 may be configured to determine values of service metrics for quick service restaurant 134. In some implementations, determinations by service metric component 112 may be based on the timing information from timing component 108. In some implementations, service metric component 112 may be configured to determine, during the event duration, values of the one or more service metrics specified by event objective information for a particular event (as obtained, e.g., by event component 110). Determinations by service metric component 112 may be made during and after events.

External metric component 114 may be configured to obtain values for service metrics and/or external service metrics. External service metrics may be service metrics for other participating quick service restaurants. For example, for a first quick service restaurant, the service metrics of a second quick service restaurants are external service metrics, and vice versa. In some implementations, values obtained by external metric component 114 may be obtained during a particular event duration and/or may pertain to services provided during the particular event duration. In some implementations, external metric component 114 may be configured to obtain one or more sets of values for external service metrics. Individual sets of values for external service metrics correspond to individual ones of the other quick service restaurants participating in a particular event. Individual sets of values for external service metrics may be based on service durations for individual instances of service being provided at the individual ones of the other quick service restaurants during a particular event duration. In some implementations, a set of values for (external) service metrics may pertain to services provided during a daily round of competition within a multi-day event. In some implementations, external metric component 114 may be configured to obtain values for external service metrics from an event administrator, event administrator interface 150, and/or external resource 128.

Result determination component 120 may be configured to determine event-specific results and/or round-specific results for one or more events. In some implementations, determinations by result determination component 120 may be based on the determined values of one or more service metrics for quick service restaurant 134 and/or the obtained one or more sets of values for external service metrics for other participating quick service restaurants (including but not limited to determinations based on aggregation, averaging, derivations, etc.). In some implementations, determinations by result determination component 120 may be made subsequent to completion of one or more events and/or rounds of events. For example, assume the service metric is average service duration per instance of service being provided at a participating quick service restaurant. Assume, for a particular event duration, the first quick service restaurant has a service metric of 60 seconds, the second quick service restaurant has a service metric of 70 seconds, and the third service restaurant has a service metric of 80 seconds. In such a case, result determination component 120 may determine that the first quick service restaurant is the winner of this particular event or round. Assume, for the same event duration, the first quick service restaurant serviced 300 vehicles, the second quick service restaurant serviced 400 vehicles, and the third service restaurant services 400 vehicles. If the service metric is number of instances of service provided at the participating quick service restaurant, result determination component 120 may determine that the third quick service restaurant is the winner of this particular event or round. Now assume, for the same event duration, the first quick service restaurant serviced 60 percent of the vehicles within its service duration goal of 120 seconds, the second quick service restaurant serviced 70 percent of the vehicles within its service duration goal of 140 seconds, and the third service restaurant serviced 50 percent of the vehicles within its service duration goal of 160 seconds. If the service metric is percentage of the instances of service being provided for which the service duration is at or below a service duration goal at the participating quick service restaurant, result determination component 120 may determine that the second quick service restaurant is the winner of this particular event or round. In some implementations, result determination component 120 may be configured to determine results based on a combination of multiple service metrics, or by using particular service metrics as conditions to qualify as a potential winner. For example, a particular result may require at least 100 vehicles serviced during the event duration, but may subsequently determine the winner based on the average service duration.

Ranking component 116 may be configured to determine a ranking order of the participating quick service restaurants. Determinations by ranking component 116 may be made during and after events and/or rounds. In some implementations, determinations by ranking component 116 may be based on determinations by result determination component 120. For example, a current ranking order may be based on the determined values of the one or more service metrics for quick service restaurant 134 and the obtained one or more sets of values for external service metrics for other participating quick service restaurants.

Presentation component 118 may be configured to effectuate one or more presentations on user interface 136. For example, presentation component 118 may present a presentation during a particular event duration. For example, presentation component 118 may present a presentation subsequent to completion of a particular event or event duration. In some implementations, presentations may include a representation of a ranking order, including but not limited to a current ranking order determined by ranking component 116. In some implementations, the representation may include one or more determined values of the one or more service metrics (e.g., determined by service metric component 112) and obtained sets of values for external service metrics (e.g., obtained by external metric component 114). The representation may further include a visual indication that depicts where quick service restaurant 134 is (currently) ranked within a determined ranking order. For example, visual indications may include numerals, gold/silver/bronze medals, colors, and/or other visual indications.

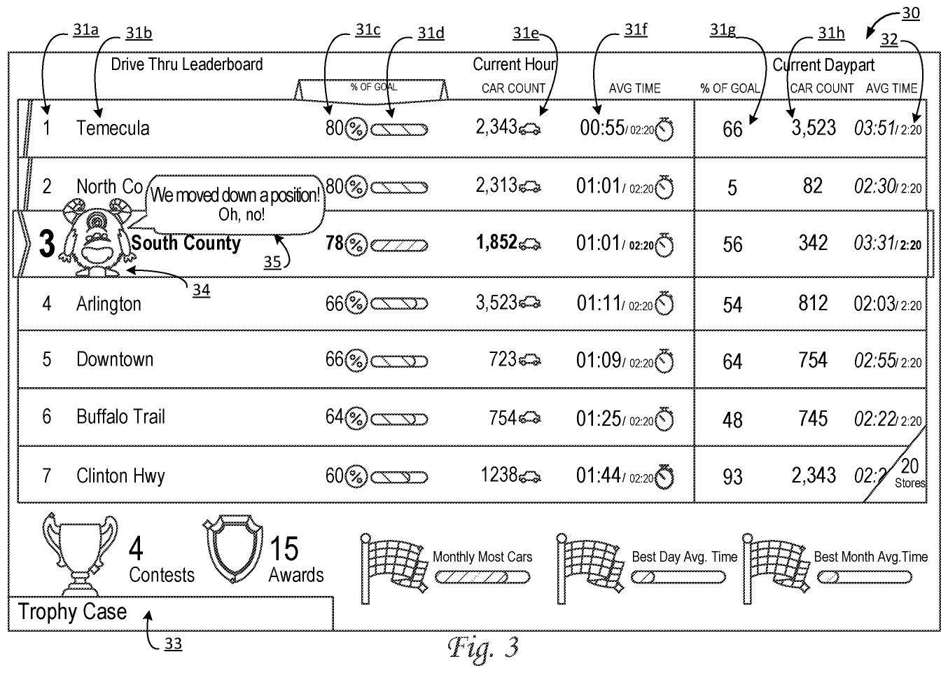

By way of non-limiting example, FIG. 3 illustrates an exemplary user interface 30 as may be provided by system 100. As depicted in user interface 30, information related to an individual quick service restaurant is presented horizontally in a row. Each row includes values of service metrics and/or information derived therefrom. For example, an element 31a depicts a ranking in a ranking order. An element 31b depicts a name or identifier of an individual quick service restaurant. An element 31c depicts a service metric for the percentage of the instances of service being provided for which the service duration is at or below a service duration goal. Depending on whether the nature of the goal is a minimum or a maximum quantity, meeting a goal may be defined as reaching a metric and/or result that is below the goal, at or below the goal, at the goal, at or above the goal, or above the goal. An element 31d depicts a progress bar related to a service metric goal. An element 31e depicts the number of instances of service that have been provided at the quick service restaurant. An element 31f depicts an average service duration per instance of service being provided at the quick service restaurant (next to a service duration goal). An element 31g depicts a service metric for the percentage of the instances of service being provided for which the service duration is at or below a service duration goal. An element 31h depicts the number of instances of service that have been provided at the quick service restaurant. An element 32 depicts an average service duration per instance of service being provided at the quick service restaurant (next to a service duration goal). Elements 31c, 31d, 31e, and 31f may be associated with a particular time period or duration, such as, e.g., a current hour. Elements 31g, 31h, and 32 may be associated with a different time period or duration, such as, e.g., a current daypart. An element 33 depicts a trophy case for the “South County” quick service restaurant, which has ranking 3. For example, the quick service restaurant identified as “Temecula” is currently in first place, and “North County” is in second place, based on the values for the particular service metric being used to determine the ranking order. User interface 30 may be associated with the “South County” quick service restaurant, as is visually indicated by, e.g., the font size used for ranking element 31a in the depicted ranking order. An individual quick service restaurant may be associated with an avatar or character, here depicted as avatar 34. The information presented in each row may depict the current status of an event or contest. For example, information 35 may be depicted subsequent to a change in the ranking order (here, “South County” moved down from ranking second to ranking third). Information 35 may include context-specific feedback provided in real-time (or with minimum delay), which may be based on a change in value of one or more service metrics. Here, information 35 may be based on the relative ranking order for multiple quick service restaurants. The number of rows and columns depicted is exemplary and not intended to be limiting in any way.

Referring to FIG. 1, in some implementations, presentation component 118 may be configured to effectuate presentation on user interface 136 of a visual indication that depicts determined event-specific results. In some implementations, determining the current ranking order and effectuating the presentation of the representation of the determined current ranking order may occur at most 1, 2, 3, 4, 5, 6, 7, 8, 9, 10, or more minutes after the pertinent timing information is obtained, e.g., from timing component 108. In some implementations, determining the current ranking order and effectuating the presentation of the representation of the determined current ranking order may occur between 1 second and 1 minute after the pertinent timing information is obtained, e.g., from timing component 108. In some implementations, a particular ranking order may be considered real-time if no more than 2 minutes pass between obtainment of pertinent timing information and presentation of (or based on) the particular ranking order.

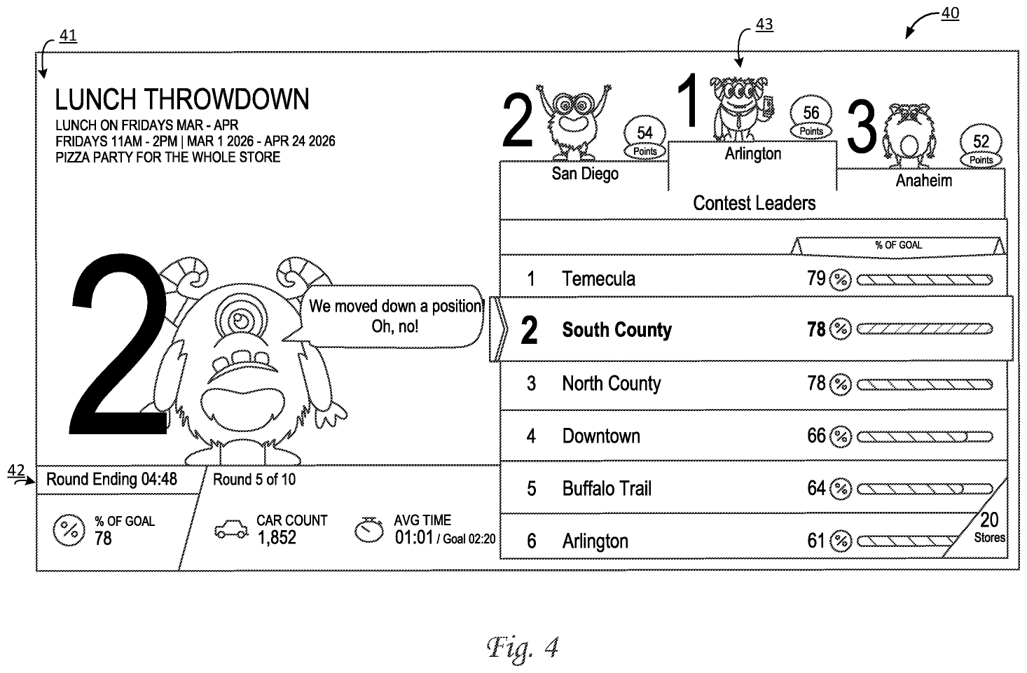

By way of non-limiting example, FIG. 4 illustrates an exemplary user interface 40 as may be provided by system 100. As depicted in user interface 40, information related to an individual quick service restaurant is presented horizontally in a row in the right half of user interface 40. Each row includes values of one or more service metrics and/or information derived therefrom. An informational element 41 includes event information, including the name of the event (“lunch throwdown”), event timing information, and award information (“pizza party for the whole store”). An informational element 42 depicts how much time is left in the current round (“4:48”), and that the current round is round 5 out of 10. An informational element 43 depicts the current ranking order based on the 4 completed rounds of competition, including the top three ranked quick service restaurants, their avatars, and their current scores (which may be based on points that are awarded after each round). Here, the “Arlington” quick service restaurant is ranked first in the ranking order for the entire event, with 56 points scored so far.

Referring to FIG. 1, award component 122 may be configured to distribute awards to quick service restaurants. In some implementations, award component 122 may be configured to distribute awards in accordance with determinations by service metric component 112, ranking component 116, result determination component 120, and/or other components of system 100. In addition to a physical reward such as a pizza party, the available awards may include one or more of (virtual) points, virtual items, bragging rights, digital trophies, award certificates of achievement, new abilities or items within a user interface, changes to avatars, changes to user interfaces, award notifications, (virtual) currency, and/or other awards. In some implementations, awards may be intangible. In some implementations, award distribution may include a transfer of information pertain to an award to quick service restaurant 134. In some implementations, award distribution may include sending electronic messages to users and/or other stakeholders pertaining to an award, e.g., to quick service restaurant 134. In some implementations, award distribution may include a presentation on user interface 136 of information pertain to an award.

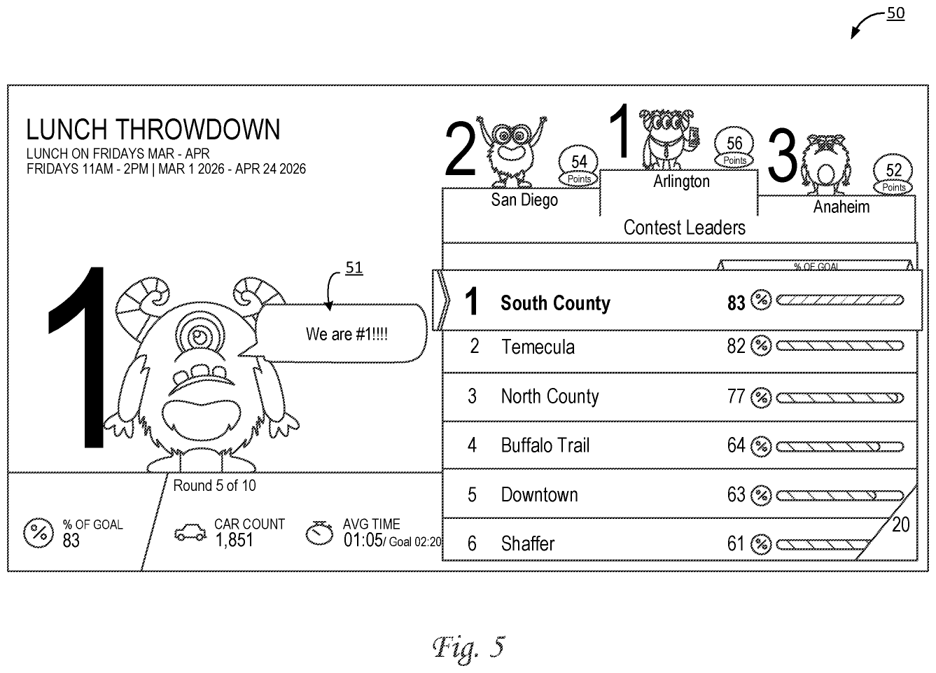

By way of non-limiting example, FIG. 5 illustrates an exemplary user interface 50 as may be provided by system 100. As depicted in user interface 50, information related to an individual quick service restaurant is presented horizontally in a row in the right half of user interface 50, similar to user interface 40 in FIG. 4. As depicted in user interface 50, the current round of competition (“round 5 of 10”) may have been completed, with the “South County” quick service restaurant being in first place in the ranking order. An informational element 51 provides context-specific and event-specific feedback.

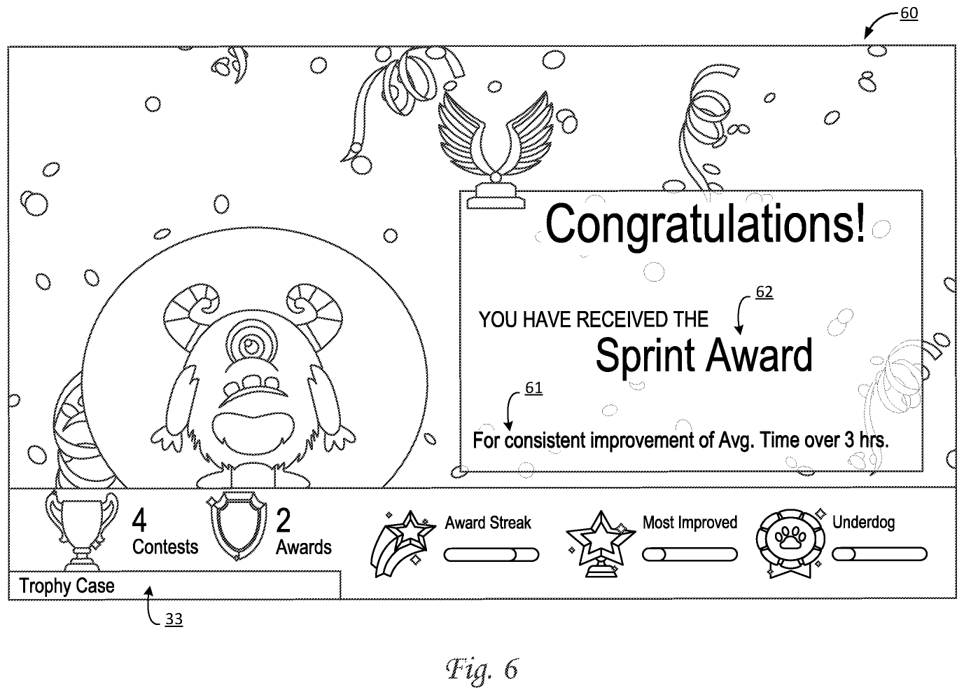

By way of non-limiting example, FIG. 6 illustrates an exemplary user interface 60 as may be provided by system 100 when a quick service restaurant has won an award in an event. As depicted in user interface 60, an informational element 62 describes the name of the award (“Sprint Award”), and an informational element 61 describes the criteria for winning the award (“consistent improvement of average time over 3 hours”). An element 33 depicts a trophy case for an individual quick service restaurant, including information regarding previously awarded awards.

Referring to FIG. 1, feedback component 124 may be configured to determine context-specific feedback for quick service restaurant 134. In some implementations, context-specific feedback may be related to one or more service metrics for quick service restaurant 134. For example, the context-specific feedback may include a notification regarding the value (or a change in value) of a particular service metric (possibly in relation to a service metric goal such as a service duration goal). In some implementations, context-specific feedback may be related to the relative ranking order of quick service restaurant 134, e.g. in relation to one or more other participating quick service restaurants. By way of non-limiting example, the context-specific feedback may include one or more of notifications regarding changes in the current ranking order, notifications regarding progress towards an individual award, notifications regarding an expected correlation between one or more future service durations and a future change in the current ranking order, and notifications regarding an expected correlation between one or more future service durations and future event-specific results.

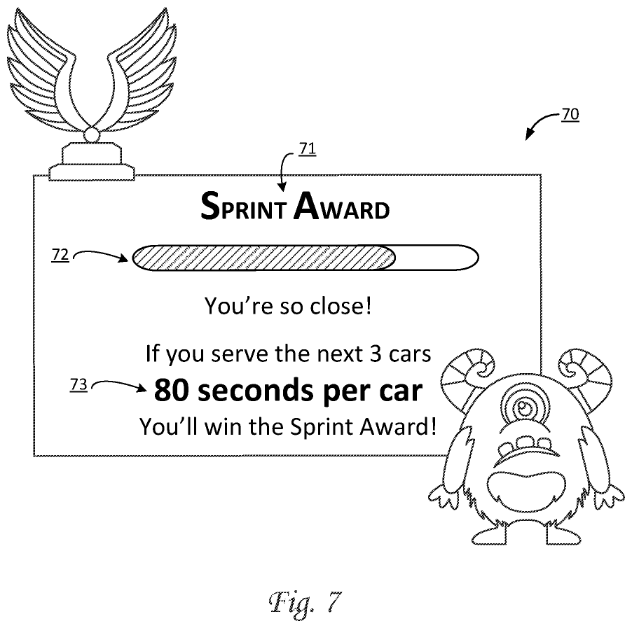

By way of non-limiting example, FIG. 7 illustrates an exemplary user interface 70 as may be provided by system 100 when a quick service restaurant is close to winning an award. As depicted in user interface 70, an informational element 71 describes the name of the award (“Sprint Award”), and an informational element 72 depicts progress towards winning this award. An informational element 73 describes the context-specific feedback for winning the award (“serve the next 3 cars in 80 seconds per car”).

Referring to FIG. 1, integration component 126 may be configured to effectuate presentations on user interface 136 of a combination of different types of information. In some implementations, integration component 126 may be configured to generate a composite presentation that includes first information (from a first component of system 100) and second information (from a second component of system 100). For example, the first information and second information may be integrated in the combined presentation. For example, the first information may include a current ranking order for a current contest and the second information may include information regarding one or more past contests (depicting, e.g., a trophy case). As another example, the first information may include round-specific results and the second information may include context-specific feedback, e.g. regarding a particular award. Other combinations of first information and second information are envisioned within the scope of this disclosure.

In some implementations, server(s) 102, client computing platform(s) 104, and/or external resources 128 may be operatively linked via one or more electronic communication links. For example, such electronic communication links may be established, at least in part, via one or more networks 13 such as the Internet and/or other networks. It will be appreciated that this is not intended to be limiting, and that the scope of this disclosure includes implementations in which server(s) 102, client computing platform(s) 104, and/or external resources 128 may be operatively linked via some other communication media.

A given client computing platform 104 may include one or more processors configured to execute computer program components. The computer program components may be configured to enable an expert or user associated with the given client computing platform 104 to interface with system 100 and/or external resources 128, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 128 may include sources of information outside of system 100, external entities participating with system 100, and/or other resources. In some implementations, some or all of the functionality attributed herein to external resources 128 may be provided by resources included in system 100.

Server(s) 102 may include electronic storage 130, one or more processors 132, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 130 may comprise non-transitory storage media that electronically stores information. The electronic storage media of electronic storage 130 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from server(s) 102, information received from client computing platform(s) 104, and/or other information that enables server(s) 102 to function as described herein.

Processor(s) 132 may be configured to provide information processing capabilities in server(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, 120, 122, 124, and/or 126, and/or other components. Processor(s) 132 may be configured to execute components 108, 110, 112, 114, 116, 118, 120, 122, 124, and/or 126, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, 124, and/or 126 are illustrated in FIG. 1 as being implemented within a single processing unit, in implementations in which processor(s) 132 includes multiple processing units, one or more of components 108, 110, 112, 114, 116, 118, 120, 122, 124, and/or 126 may be implemented remotely from the other components. The description of the functionality provided by the different components 108, 110, 112, 114, 116, 118, 120, 122, 124, and/or 126 described below is for illustrative purposes, and is not intended to be limiting, as any of components 108, 110, 112, 114, 116, 118, 120, 122, 124, and/or 126 may provide more or less functionality than is described. For example, one or more of components 108, 110, 112, 114, 116, 118, 120, 122, 124, and/or 126 may be eliminated, and some or all of its functionality may be provided by other ones of components 108, 110, 112, 114, 116, 118, 120, 122, 124, and/or 126. As another example, processor(s) 132 may be configured to execute one or more additional components that may perform some or all of the functionality attributed below to one of components 108, 110, 112, 114, 116, 118, 120, 122, 124, and/or 126.

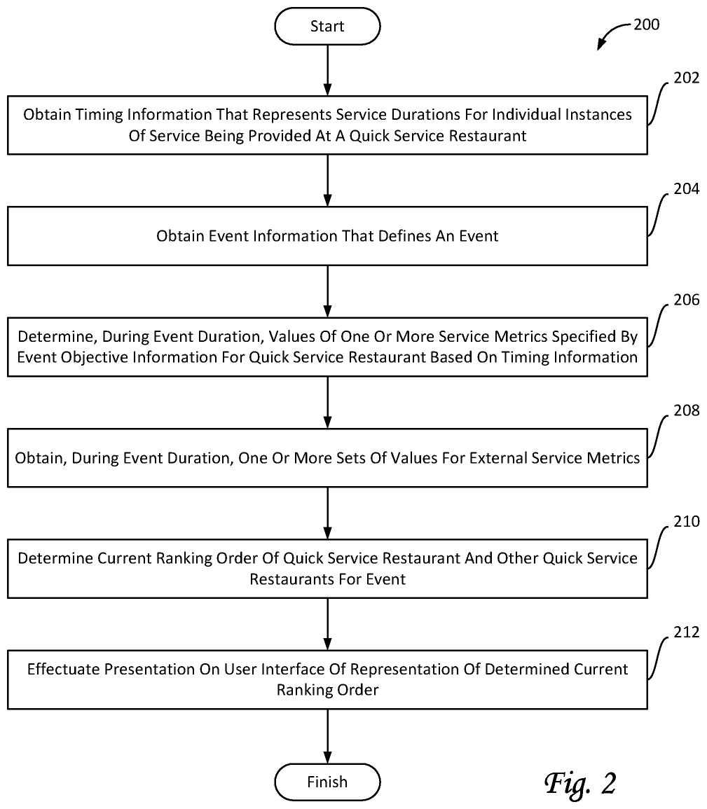

FIG. 2 illustrates a method 200 for providing a user interface to employees of a quick service restaurant, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining, from a timing system that includes one or both of a timer and/or a sensor, timing information that represents service durations for individual instances of service being provided at a quick service restaurant. Operation 202 may be performed by one or more hardware processors configured by machine-readable instructions including a component that is the same as or similar to timing component 108, in accordance with one or more implementations.

An operation 204 may include obtaining event information that defines an event. The event information may include event timing information, event participant information, and event objective information for the event. The event timing information may specify an event start time and an event stop time for the event, thereby defining an event duration between the event start time and the event stop time. The event participant information may identify other quick service restaurants participating in the event. The event objective information may specify one or more service metrics on which the quick service restaurants are competing during the event. Operation 204 may be performed by one or more hardware processors configured by machine-readable instructions including a component that is the same as or similar to event component 110, in accordance with one or more implementations.

An operation 206 may include determining, during the event duration, values of the one or more service metrics specified by the event objective information for the quick service restaurant based on the timing information. Operation 206 may be performed by one or more hardware processors configured by machine-readable instructions including a component that is the same as or similar to service metric component 112, in accordance with one or more implementations.

An operation 208 may include obtaining, during the event duration, one or more sets of values for external service metrics. Individual sets of values for external service metrics may correspond to individual ones of the other quick service restaurants participating in the event. Individual sets of values for external service metrics may be based on service durations for individual instances of service being provided at the individual ones of the other quick service restaurants during the event duration. Operation 208 may be performed by one or more hardware processors configured by machine-readable instructions including a component that is the same as or similar to external metric component 114, in accordance with one or more implementations.

An operation 210 may include determining a current ranking order of the quick service restaurant and the other quick service restaurants for the event. The current ranking order may be based on the determined values of the one or more service metrics and the obtained one or more sets of values for external service metrics. Operation 210 may be performed by one or more hardware processors configured by machine-readable instructions including a component that is the same as or similar to ranking component 116, in accordance with one or more implementations.

An operation 212 may include effectuating presentation on a user interface, during the event duration, of a representation of the determined current ranking order. The representation may include one or more of the determined values of the one or more service metrics and the obtained one or more sets of values for external service metrics. The representation may further include a visual indication that depicts where the quick service restaurant is currently ranked within the determined ranking order. Operation 212 may be performed by one or more hardware processors configured by machine-readable instructions including a component that is the same as or similar to presentation component 118, in accordance with one or more implementations.

In some implementations, a system as described in this disclosure may be used for customer-oriented businesses that are not quick service restaurants, provided there are defined moments an instance of service being provided starts and ends. Stores, pharmacies, medical offices, and/or other types of customer-oriented businesses may measure service durations and used these measurements to define service metrics and/or other metrics, which may in turn form the basis for the definition of time-limited events, a ranking order, one or more user interfaces similar to the user interfaces described above, one or more awards, and/or any other entity or object described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for providing a user interface to employees of a quick service restaurant, the system comprising:
one or more hardware processors configured by machine-readable instructions to:
obtain, from a timing system that includes one or both of a timer and/or a sensor, timing information that represents service durations for individual instances of service being provided at the quick service restaurant;
obtain event information that defines an event, the event information including event timing information, event participant information, and event objective information for the event, the event timing information specifying an event start time and an event stop time for the event, thereby defining an event duration between the event start time and the event stop time, the event participant information identifying other quick service restaurants participating in the event, and the event objective information specifying one or more service metrics on which the quick service restaurants are competing during the event;
determine, during the event duration, values of the one or more service metrics specified by the event objective information for the quick service restaurant based on the timing information;
obtain, during the event duration, one or more sets of values for external service metrics, wherein individual sets of values for external service metrics correspond to individual ones of the other quick service restaurants participating in the event, and wherein individual sets of values for external service metrics are based on service durations for individual instances of service being provided at the individual ones of the other quick service restaurants during the event duration;
determine a current ranking order of the quick service restaurant and the other quick service restaurants for the event, wherein the current ranking order is based on the determined values of the one or more service metrics and the obtained one or more sets of values for external service metrics; and
effectuate presentation on the user interface, during the event duration, of a representation of the determined current ranking order, wherein the representation includes one or more of the determined values of the one or more service metrics and the obtained one or more sets of values for external service metrics, and wherein the representation further includes a visual indication that depicts where the quick service restaurant is currently ranked within the determined ranking order.

2. The system of claim 1, wherein individual instances of service being provided at the quick service restaurant includes a first instance of service being provided to a first person in a first vehicle and a second instance of service being provided to one or more people in a second vehicle.

3. The system of claim 1, wherein the one or more service metrics include one or more of average service duration per instance of service being provided at the quick service restaurant, percentage of the instances of service being provided for which the service duration is at or below a service duration goal, and/or number of instances of service being provided at the quick service restaurant.

4. The system of claim 3, wherein determining the values of the one or more service metrics is performed during the event duration or during a predetermined time period.

5. The system of claim 1, wherein determining the current ranking order and effectuating the presentation of the representation of the determined current ranking order occurs at most 10 minutes after the timing information is obtained.

6. The system of claim 1, wherein the event is associated with one or more awards that can be awarded to any of the quick service restaurants participating in the event;
wherein the one or more hardware processors are further configured by machine-readable instructions to determine event-specific results for the event based on the determined values of the one or more service metrics and the obtained one or more sets of values for external service metrics, subsequent to completion of the event;
wherein the one or more hardware processors are further configured by machine-readable instructions to distribute individual ones of the one or more awards in accordance with the determined event-specific results.

7. The system of claim 6, wherein the one or more hardware processors are further configured by machine-readable instructions to:
effectuate presentation on the user interface of a visual indication that depicts the determined event-specific results.

8. The system of claim 6, wherein the one or more hardware processors are further configured by machine-readable instructions to:
determine context-specific feedback for the quick service restaurant, wherein the context-specific feedback includes one or more of notifications regarding changes in the current ranking order, notifications regarding progress towards an individual award, notifications regarding an expected correlation between one or more future service durations and a future change in the current ranking order, and/or notifications regarding an expected correlation between one or more future service durations and future event-specific results; and
effectuate presentation on the user interface of the determined context-specific feedback.

9. The system of claim 1, wherein the event spans multiple days and includes individual rounds of competition occurring on different days.

10. The system of claim 1, wherein the event duration is defined as a duration between 2 and 4 hours.

11. A method for providing a user interface to employees of a quick service restaurant, the method comprising:
obtaining, from a timing system that includes one or both of a timer and/or a sensor, timing information that represents service durations for individual instances of service being provided at the quick service restaurant;
obtaining event information that defines an event, the event information including event timing information, event participant information, and event objective information for the event, the event timing information specifying an event start time and an event stop time for the event, thereby defining an event duration between the event start time and the event stop time, the event participant information identifying other quick service restaurants participating in the event, and the event objective information specifying one or more service metrics on which the quick service restaurants are competing during the event;
determining, during the event duration, values of the one or more service metrics specified by the event objective information for the quick service restaurant based on the timing information;
obtaining, during the event duration, one or more sets of values for external service metrics, wherein individual sets of values for external service metrics correspond to individual ones of the other quick service restaurants participating in the event, and wherein individual sets of values for external service metrics are based on service durations for individual instances of service being provided at the individual ones of the other quick service restaurants during the event duration;
determining a current ranking order of the quick service restaurant and the other quick service restaurants for the event, wherein the current ranking order is based on the determined values of the one or more service metrics and the obtained one or more sets of values for external service metrics; and
effectuating presentation on the user interface, during the event duration, of a representation of the determined current ranking order, wherein the representation includes one or more of the determined values of the one or more service metrics and the obtained one or more sets of values for external service metrics, and wherein the representation further includes a visual indication that depicts where the quick service restaurant is currently ranked within the determined ranking order.

12. The method of claim 11, wherein individual instances of service being provided at the quick service restaurant includes a first instance of service being provided to a first person in a first vehicle and a second instance of service being provided to one or more people in a second vehicle.

13. The method of claim 11, wherein the one or more service metrics include one or more of average service duration per instance of service being provided at the quick service restaurant, percentage of the instances of service being provided for which the service duration is at or below a service duration goal, and/or number of instances of service being provided at the quick service restaurant.

14. The method of claim 13, wherein determining the values of the one or more service metrics is performed during the event duration or during a predetermined time period.

15. The method of claim 11, wherein determining the current ranking order and effectuating the presentation of the representation of the determined current ranking order occurs at most 10 minutes after the timing information is obtained.

16. The method of claim 11, wherein the event is associated with one or more awards that can be awarded to any of the quick service restaurants participating in the event;
determining event-specific results for the event based on the determined values of the one or more service metrics and the obtained one or more sets of values for external service metrics, subsequent to completion of the event; and
distributing individual ones of the one or more awards in accordance with the determined event-specific results.

17. The method of claim 16, further comprising:
effectuating presentation on the user interface of a visual indication that depicts the determined event-specific results.

18. The method of claim 16, further comprising:
determining context-specific feedback for the quick service restaurant, wherein the context-specific feedback includes one or more of notifications regarding changes in the current ranking order, notifications regarding progress towards an individual award, notifications regarding an expected correlation between one or more future service durations and a future change in the current ranking order, and/or notifications regarding an expected correlation between one or more future service durations and future event-specific results; and
effectuating presentation on the user interface of the determined context-specific feedback.

19. The method of claim 11, wherein the event spans multiple days and includes individual rounds of competition occurring on different days.

20. The method of claim 11, wherein the event duration is defined as a duration between 2 and 4 hours.
